(19) United States
(12) Patent Application Publication
(10) Pub. No.: US 2024/0411463 A1
(43) Pub. Date: Dec. 12, 2024

(54) QUEUED CURRENT LEVEL ADJUSTMENT IN A FLASH MEMORY SYSTEM

(71) Applicant: QUALCOMM Incorporated, San Diego, CA (US)

(72) Inventors: Chintalapati Bharath Sai Varma, Hyderabad (IN); Santhosh Reddy Akavaram, Hyderabad (IN); Prakhar Srivastava, Lucknow (IN); Rajendra Varma Pusapati, Hyderabad (IN); Sai Naresh Gajapaka, Hyderabad (IN)

(21) Appl. No.: 18/331,612

(22) Filed: Jun. 8, 2023

(51) Int. Cl. G06F 3/06

(52) U.S. Cl. CPC G06F 3/0625; G06F 3/0659; G06F 3/0679; G06F 11/3058

(57) ABSTRACT

This disclosure provides systems, methods, and devices for memory systems that support queued current level adjustment in a flash memory system. In a first aspect, a method of accessing data in a flash memory system includes receiving, at a memory controller of a memory system from a host device, a first request to adjust a current level of a memory module of the memory system, storing, by the memory controller, an indication of the first request in a register associated with the memory controller, and transmitting, to the host device, an indication that the first request is pending. Other aspects and features are also claimed and described.

### TECHNICAL FIELD

Aspects of the present disclosure relate generally to an apparatus and method for controlling a memory device. Some aspects may, more particularly, relate to an apparatus and method for controlling operations for queued current level adjustment in a flash memory system.

### INTRODUCTION

As the value and use of information continues to increase, individuals and businesses seek additional ways to process and store information. In addition, the use of information in various locations and desired portability of information is increasing. For this reason, users are increasingly turning towards the use of portable electronic devices, such as mobile phones, digital cameras, laptop computers and the like. Portable electronic devices generally employ a memory system using a memory device for storing data. A memory system may be used as a main memory or an auxiliary memory of a portable electronic device.

The memory device of the memory system may include one kind or a combination of kinds of storage. For example, magnetic-based memory systems, such as hard disk drives (HDDs), store data by encoding data as a combination of small magnets. As another example, optical-based memory systems, such as digital versatile discs (DVDs) and Blu-ray media, store data by encoding data as physical bits that cause different reflections when illuminated by a light source. As a further example, electronic memory devices store data as collections of electrons that can be detected through voltage and/or current measurements.

Electronic memory devices can be advantageous in certain systems in that they may access data quickly and consume a small amount of power. Examples of an electronic memory device having these advantages include universal serial bus (USB) memory devices (sometimes referred to as “memory sticks”), a memory card (such as used in some cameras and gaming systems), and solid state drive (SSDs) (such as used in laptop computers). NAND flash memory is one kind of memory device that may be used in electronic memory devices. NAND flash memory is manufactured into memory cards or flash disks. Example memory cards include compact flash (CF) cards, multimedia cards (eMMCs), smart media (SM) cards, and secure digital (SD) cards.

A memory system may, in some cases, be integrated with or otherwise connected to a host device, such as an electronic device. For example, memory systems may be integrated with host devices in a system on chip (SoC). As one particular example, a flash memory system, which may be a universal flash storage (UFS) memory system, may be integrated into an electronic device, such as an access point (AP), station (STA), user equipment (UE), base station, modem, camera, automobile, or other system.

One standard for organization and operation of electronic memory devices is the Universal Flash Storage (UFS) standard. The UFS standard was introduced as a successor to the eMMC (embedded MultiMediaCard) standard to offer higher performance and lower power consumption for mobile and other embedded devices. UFS provides support for a range of features such as multi-lane configurations, command queuing, and power-saving modes that enable high-speed data transfer rates, low latency, and long battery life. The UFS standard specifies many parameters for structuring, reading data from, and writing data to UFS-compliant memory devices. For example, UFS-compliant devices may include digital cameras, mobile phones, consumer electronic devices, and other devices with internal memory capacity. UFS-compliant memory may include memory embedded within electronic devices and removable memory cards, and UFS memory devices may implement NAND flash memory.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

Memory systems, such as flash memory systems configured to operate according to the UFS standard, may be operate at different current levels, such as different levels of current consumption. To prevent requests from a host device to adjust a current level of a memory system from being discarded when commands to read from or write to the memory system are pending, a request to adjust a current level of the memory system may be stored in a queue register associated with the memory system, and a host device connected to the memory system may be notified that the request is pending. Then, when commands to read from or write to the memory system are no longer pending, such as when a command queue of the memory system is empty, the current level of the memory system may be adjusted according to the request, and the host device may be notified of such an adjustment. As another example, if commands to read from or write to the memory system are pending, the host device may hold the request in a queue and may transmit the request once the commands are no longer pending. Furthermore, if the memory system receives the request to adjust the current level while one or more background operations are being performed on the memory system, the memory system may notify the host device to suspend performance of the one or more background operations, adjust the current level according to the request, and notify the host device to resume performance of the one or more background operations after the current level has been adjusted. Such notification may be performed through use of one or more bits of an exception event register. Thus, instead of discarding a request to adjust a current level while operations are being performed on and/or pending for a memory system, which may require retransmission of such a request, the request may be held until the memory system is ready to perform the adjustment.

In one aspect of the disclosure, a memory device includes a memory controller coupled to a memory module through a data channel and configured to access data stored in the memory module through the data channel; and coupled to a host device through a memory interface and configured to communicate with the host device over the memory interface. The memory controller of the memory device may be configured to perform operations including receiving, from the host device, a first request to adjust a current level of the memory module, storing an indication of the first request in a register associated with the memory controller, and transmitting, to the host device, an indication that the first request is pending. In another aspect of the disclosure, a method for performing these operations by a processor by executing instructions stored in a memory coupled to the processor is also disclosed. In an additional aspect of the disclosure, a non-transitory computer-readable medium stores instructions that, when executed by a processor, cause the processor to perform these operations.

In an additional aspect of the disclosure, the memory controller of the memory device may be configured to perform operations including receiving, from the host device, a first request to adjust a current level of the memory module while one or more background operations are being performed on the memory module and transmitting, to the host device after receiving the first request, a first notification to instruct the host device to suspend the one or more background operations. In another aspect of the disclosure, a method for performing these operations by a processor by executing instructions stored in a memory coupled to the processor is also disclosed. In an additional aspect of the disclosure, a non-transitory computer-readable medium stores instructions that, when executed by a processor, cause the processor to perform these operations.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating a data processing system including a memory system in accordance with an embodiment of the present invention.

FIG. 2 is a block diagram illustrating an example electronic device including the memory system according to one or more aspects of the disclosure.

FIG. 3 is a block diagram illustrating components for facilitating access to a flash memory device from a host device according to some embodiments of the disclosure.

FIG. 4 is a block diagram illustrating a system including a host device and a flash memory system that supports queued adjustment of a current level of the memory system according to some embodiments of the disclosure.

FIG. 5 is a call diagram illustrating a process for queued adjustment of a current level of a flash memory system according to some embodiments of the disclosure.

FIG. 6 is a call diagram illustrating a process for queued adjustment of a current level of a flash memory system according to some embodiments of the disclosure.

FIG. 7 is flow chart illustrating a method for queued adjustment of a current level by a flash memory system according to some embodiments of the disclosure by a host controller according to some embodiments of the disclosure.

FIG. 8 is flow chart illustrating a method for queued adjustment of a current level by a flash memory system according to some embodiments of the disclosure by a host controller according to some embodiments of the disclosure.

FIG. 9 is flow chart illustrating a method for queued adjustment of a current level by a flash memory system according to some embodiments of the disclosure by a host controller according to some embodiments of the disclosure.

FIG. 10 is flow chart illustrating a method for queued adjustment of a current level by a flash memory system according to some embodiments of the disclosure by a host controller according to some embodiments of the disclosure.

FIG. 11 is a layout of an example exception event status register according to some embodiments of the disclosure.

FIG. 12 is a layout of an example exception event control register according to some embodiments of the disclosure.

FIG. 13 is a layout of an example current adjustment request queue register according to some embodiments of the disclosure.

FIG. 14 is a block diagram illustrating details of an example wireless communication system according to one or more aspects.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The present disclosure provides systems, apparatus, methods, and computer-readable media that support data processing, including techniques for storing, retrieving, and organizing data in a memory system. Aspects of this disclosure provide for operations and data structures used in those operations for receiving, from a host device, a request to adjust a current level of a memory module of a memory system, storing an indication of the request in a register, and transmitting an indication that the request is pending to a host device. Aspects of this disclosure further provide for operations and data structures used in those operations for determining that a command queue is empty, adjusting a current level of the memory module based on the request and the determination that the command queue is empty, and notifying the host device that the current level has been adjusted. Aspects of this disclosure also provide for operations and data structures used in those operations for delay in transmission of a request to adjust a current level from a host device to a memory system when one or more operations are queued to be performed on the memory system, receipt of the request to adjust the current level of the memory system, transmission of a notification to instruct the host device to suspend one or more background operations, adjustment of the current level based on the request when the background operations are suspended, and transmission, to the host device, of a notification to resume performance of the background operations after the current level is adjusted.

Particular implementations of the subject matter described in this disclosure may be implemented to realize one or more of the following potential advantages or benefits. In some aspects, the present disclosure provides techniques for improved performance of a memory system, such as reduced power consumption and latency in memory systems, such as UFS memory systems. For example, storage of a request to adjust a current level received while one or more operations are queued for the memory system, rather than discarding such a request, may reduce latency through reduction or elimination of repeated requests to adjust the current level. Likewise, suspension of background processes to adjust a current level may allow for earlier reduction in a current level of the memory system before the background operations are completed, reducing power consumption and enhancing battery life. Suspension of background processes to adjust a current level may also allow for earlier increase of a current level of a memory system before the background operations are completed, allowing for enhanced performance before background processes are completed.

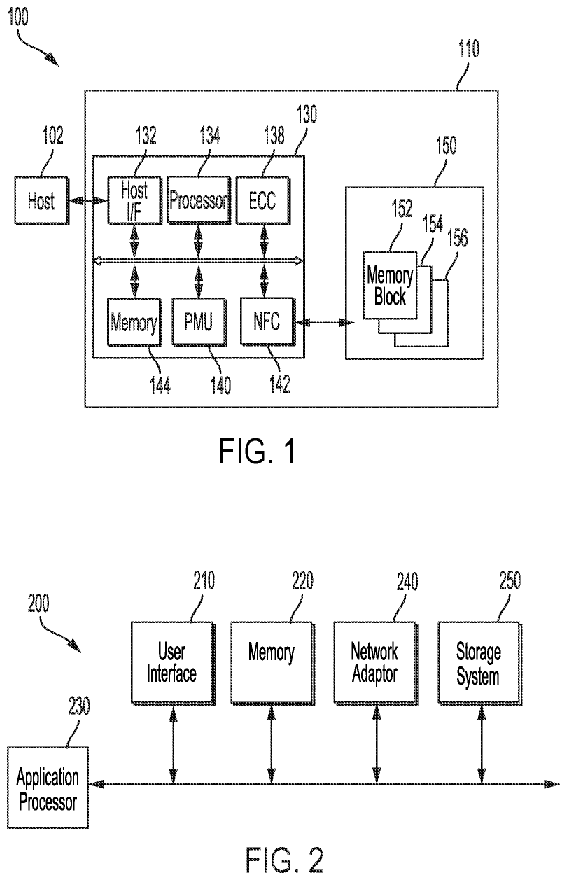

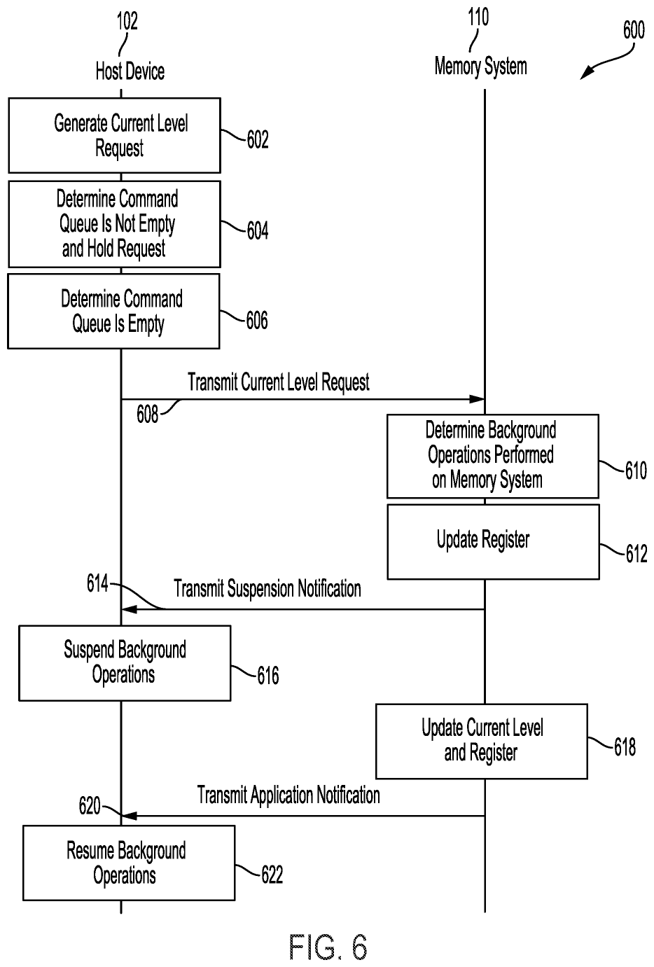

Memory may be used in a computing system organized as illustrated in FIG. 1. FIG. 1 illustrates a data processing system 100, such as may be included in a mobile computing device, according to one or more aspects of the disclosure. A memory system 110 may couple to a host device 102 through one or more channels. For example, the host device 102 and memory system 110 may be coupled through a serial interface including a single channel for the transport of data or a parallel interface including two or more channels for the transport of data. In some aspects, control data may be transferred through the same channel(s) as the data or the control data may be transferred through additional channels. The host device 102 may be, for example, a portable electronic device such as a mobile phone, an MP3 player, a laptop computer, or a non-portable electronic device such as a desktop computer, a game player, a television (TV), a media player, or a projector. As another example, the host device 102 may be an automotive computer system. In some examples, the memory system 110 may be included in the host device 102. Thus, the data processing system 100 may be any of the example host devices described herein including the memory system 110. Additional example host devices are illustrated and described with reference to FIG. 6.

The memory system 110 may execute operations in response to commands (e.g., a request) from the host device 102. For example, the memory system 110 may store data provided by the host device 102 and the memory system 110 may also provide stored data to the host device 102. The memory system 110 may be used as a main memory, short-term memory, or long-term memory by the host device 102. As one example of main memory, the host device 102 may use the memory system 110 to supplement or replace a system memory by using the memory system 110 to store temporary data such as data relating to operating systems and/or threads executing in the operation system. As one example of short-term memory, the host device 102 may use the memory system 110 to store a page file for an operating system. As one example of long-term memory, the host device 102 may use the memory system 110 to store user files (e.g., documents, videos, pictures) and/or application files (e.g., word processing executable, gaming application).

The memory system 110 may be implemented with any one of various storage devices, according to the protocol of a host interface for the one or more channels coupling the memory system 110 to the host device 102. The memory system 110 may be implemented with any one of various storage devices, such as a solid state drive (SSD), a multimedia card (MMC), an embedded MMC (eMMC), a reduced size MMC (RS-MMC), a micro-MMC, a secure digital (SD) card, a mini-SD, a micro-SD, a universal serial bus (USB) storage device, a universal flash storage (UFS) device, a compact flash (CF) card, a smart media (SM) card, or a memory stick.

The memory system 110 may include a memory module 150 and a controller 130 coupled to the memory module 150 through one or more channels. The memory module 150 may store and retrieve data in memory blocks 152, 154, and 156 under control of the controller 130, which may execute commands received from the host device 102. The controller 130 is configured to control data exchange between the memory module 150 and the host device 102. The storage components, such as blocks 152, 154, and 156 in the memory module 150 may be implemented as volatile memory device, such as, a dynamic random access memory (DRAM) and a static random access memory (SRAM), or a non-volatile memory device, such as a read only memory (ROM), a programmable ROM (PROM), an erasable programmable ROM (EPROM), an electrically erasable programmable ROM (EEPROM), a ferroelectric random access memory (FRAM), a phase-change RAM (PRAM), a magnetoresistive RAM (MRAM), a resistive RAM (SCRAM), or a NAND flash memory.

The controller 130 and the memory module 150 may be formed as integrated circuits on one or more semiconductor dies (or other substrate). In some aspects, the controller 130 and the memory module 150 may be integrated into one chip. In some aspects, the memory module 150 may include one or more chips coupled in series or parallel with each other and coupled to the controller 130, which is on a separate chip. In some aspects, the memory module 150 and controller 130 chips are integrated in a single package, such as in a package on package (POP) system. In some aspects, the memory system 110 is integrated on a single chip with one or more or all of the components (e.g., application processor, system memory, digital signal processor, modem, graphics processor unit, memory interface, input/output interface, network adaptor) of the host device 102, such as in a system on chip (SoC). The controller 130 and the memory module 150 may be integrated into one semiconductor device to form a memory card, such as, for example, a Personal Computer Memory Card International Association (PCMCIA) card, a compact flash (CF) card, a smart media card (SMC), a memory stick, a multimedia card (MMC), an RS-MMC, a micro-MMC, a secure digital (SD) card, a mini-SD, a micro-SD, an SDHC, and a universal flash storage (UFS) device.

The controller 130 of the memory system 110 may control the memory module 150 in response to commands from the host device 102. The controller 130 may execute read commands to provide the data from the memory module 150 to the host device 102. The controller 130 may execute write commands to store data provided from the host device 102 into the memory module 150. The controller 130 may execute other commands to manage data in the memory module 150, such as program and erase commands. The controller 130 may also execute other commands to manage control of the memory system 110, such as setting configuration registers of the memory system 110. By executing commands in accordance with the configuration specified in the configuration registers, the controller 130 may control operations of the memory module 150, such as read, write, program, and erase operations.

The controller 130 may include several components configured for performing the received commands. For example, the controller 130 may include a host interface (I/F) unit 132, a processor 134, an error correction code (ECC) unit 138, a power management unit (PMU) 140, a NAND flash controller (NFC) 142, and/or a memory 144. The power management unit (PMU) 140 may provide and manage power for components within the controller 130 and/or the memory module 150.

The host interface unit 132 may process commands and data provided from the host device 102, and may communicate with the host device 102, through at least one of various interface protocols such as universal serial bus (USB), multimedia card (MMC), peripheral component interconnect express (PCI-e), serial attached SCSI (SAS), serial advanced technology attachment (SATA), parallel advanced technology attachment (PATA), small computer system interface (SCSI), enhanced small disk interface (ESDI), and integrated drive electronics (IDE). For example, the host interface 132 may be a parallel interface such as an MMC interface, or a serial interface such as an ultra-high speed class 1 (UHS-I)/UHS class 2 (UHS-II) or a universal flash storage (UFS) interface.

The ECC unit 138 may detect and correct errors in the data read from the memory module 150 during the read operation. The ECC unit 138 may not correct error bits when the number of the error bits is greater than a threshold number of correctable error bits, which may result in the ECC unit 138 outputting an error correction fail signal indicating failure in correcting the error bits. In some aspects, no ECC unit 138 may be provided or the ECC unit 138 may be configurable to be active for some or all of the memory module 150. The ECC unit 138 may perform an error correction operation using a coded modulation such as a low-density parity check (LDPC) code, a Bose-Chaudhuri-Hocquenghem (BCH) code, a turbo code, a Reed-Solomon (RS) code, a convolution code, a recursive systematic code (RSC), a trellis-coded modulation (TCM), or a Block coded modulation (BCM).

The NFC 142 provides an interface between the controller 130 and the memory module 150 to allow the controller 130 to control the memory module 150 in response to a commands received from the host device 102. The NFC 142 may generate control signals for the memory module 150, such as signals for rowlines and bitlines, and process data under the control of the processor 134. Although NFC 142 is described as a NAND flash controller, other controllers may perform similar function for other memory types used as memory module 150.

The memory 144 may serve as a working memory of the memory system 110 and the controller 130. The memory 144 may store data for driving the memory system 110 and the controller 130. When the controller 130 controls an operation of the memory module 150 such as, for example, a read, write, program or erase operation, the memory 144 may store data which are used by the controller 130 and the memory module 150 for the operation. The memory 144 may be implemented with a volatile memory such as, for example, a static random access memory (SRAM) or a dynamic random access memory (DRAM). In some aspects, the memory 144 may store address mappings, a program memory, a data memory, a write buffer, a read buffer, a map buffer, and the like.

The processor 134 may control the general operations of the memory system 110, and a write operation or a read operation for the memory module 150, in response to a write request or a read request received from the host device 102, respectively. For example, the processor 134 may execute firmware, which may be referred to as a flash translation layer (FTL), to control the general operations of the memory system 110. The processor 134 may be implemented, for example, with a microprocessor or a central processing unit (CPU), or an application-specific integrated circuit (ASIC).

FIG. 2 is a block diagram illustrating an example electronic device including the memory system 100 according to one or more aspects of the disclosure. The electronic device 200 may include a user interface 210, a memory 220, an application processor 230, a network adaptor 240, and a storage system 250 (which may be one embodiment of the memory system 100 of FIG. 1). The application processor 230 may be coupled to the other components through a bus, such as a peripheral component interface (PCI) bus, including a PCI express (PCIe) bus.

The application processor 230 may execute computer program code, including applications, drivers, and operating systems, to coordinate performing of tasks by components included in the electronic device 200. For example, the application processor 230 may execute a storage driver for accessing the storage system 250. The application processor 230 may be part of a system-on-chip (SoC) that includes one or more other components shown in electronic device 200.

The memory 220 may operate as a main memory, a working memory, a buffer memory or a cache memory of the electronic device 200. The memory 220 may include a volatile random access memory such as a dynamic random access memory (DRAM), a synchronous dynamic random access memory (SDRAM), a double data rate (DDR) SDRAM, a DDR2 SDRAM, a DDR3 SDRAM, a low power double data rate (LPDDR) SDRAM, an LPDDR2 SDRAM, an LPDDR3 SDRAM, an LPDDR4 SDRAM, an LPDDR5 SDRAM, or an LPDDR6 SDRAM, or a nonvolatile random access memory such as a phase change random access memory (PRAM), a resistive random access memory (ReRAM), a magnetic random access memory (MRAM) and a ferroelectric random access memory (FRAM). In some aspects, the application processor 230 and the memory 220 may be combined using a package-on-package (POP).

The network adaptor 240 may communicate with external devices. For example, the network adaptor 240 may support wired communications and/or various wireless communications such as code division multiple access (CDMA), global system for mobile communication (GSM), wideband CDMA (WCDMA), CDMA-2000, time division multiple access (TDMA), long term evolution (LTE), worldwide interoperability for microwave access (WiMAX), wireless local area network (WLAN), ultra-wideband (UWB), Bluetooth, wireless display (Wi-Di), and so on, and may thereby communicate with wired and/or wireless electronic appliances, for example, a mobile electronic appliance.

The storage system 250 may store data, for example, data received from the application processor 230, and transmit data stored therein, to the application processor 230. The storage system 250 may be a non-volatile semiconductor memory device, such as a phase-change RAM (PRAM), a magnetic RAM (MRAM), a resistive RAM (ReRAM), a NAND flash memory, a NOR flash memory, or a 3-dimensional (3-D) NAND flash memory. The storage system 250 may be a removable storage medium, such as a memory card or an external drive. For example, the storage system 250 may correspond to the memory system 110 described above with reference to FIG. 1 and may be a SSD, eMMC, UFS, or other flash memory system.

The user interface 210 provide one or more graphical user interfaces (GUIs) for inputting data or commands to the application processor 230 or for outputting data to an external device. For example, the user interface 210 may include user input interfaces, such as a virtual keyboard, a touch screen, a camera, a microphone, a gyroscope sensor, or a vibration sensor, and user output interfaces, such as a liquid crystal display (LCD), an organic light emitting diode (OLED) display device, an active matrix OLED (AMOLED) display device, a light emitting diode (LED), a speaker, or a haptic motor.

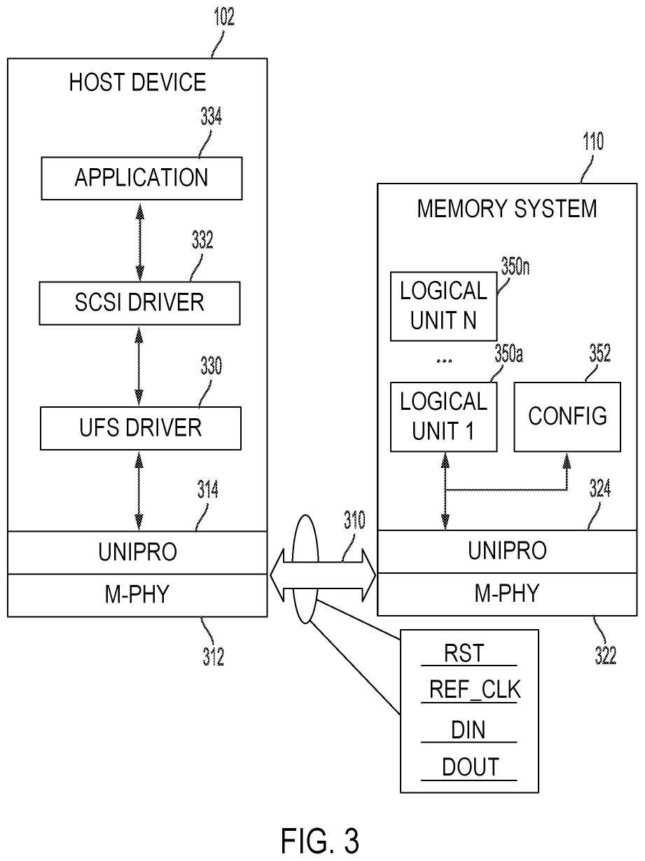

FIG. 3 is a block diagram illustrating components for facilitating access to a flash memory system from a host device according to some embodiments of the disclosure. The host device 102 accesses the memory system 110 through a first interface 310. The first interface may, for example, be a memory interface such as a physical interface (PHY) connecting the host device 102 to the memory system 110. The host device 102 may include physical layer access block 312, which is configured to generate signals for output to the memory interface 310 and process signals received through the memory interface 310. The memory system 110 includes a similarly-configured physical layer access block 322 for communicating on the memory interface 310. One example physical layer specification for communicating on the memory interface 310 is the MIPI M-PHY™ physical layer specification.

The host device 102 also includes a data link layer block 314 configured to format frames of data for transmission on the memory interface 310. The frames may be provided to the physical layer access block 312 for transmission. The data link layer block 314 may receive frames from the physical layer access block 312 and decode frames of data received on the memory interface 310. The memory system 110 includes a similarly-configured data link layer block 324 for processing frames transmitted on or received on the memory interface 310 by the physical layer access block 322. One example data link protocol for communicating on a MIPI M-PHY™ physical link is the MIPI UNIPRO™ specification.

The memory system 110 includes N logical units 350a-n comprising logical memory blocks for storing information including user data (e.g., user documents, application data) and configuration data (e.g., information regarding operation of the memory system 110). The logical units 350a-n may map to portions of the physical memory blocks 152, 154, and 156. Some of the logical units 350a-n or portions of the logical units 350a-n may be configured with write protection, with boot capability, as a specific memory type (e.g., default, system code, non-persistent, enhanced), with priority access, or with replay protection as a replay protected memory block (RPMB). The physical layer access block 322 and the data link layer block 324 perform operations of a memory controller for the memory system 110 for storing and retrieving data in logical units 350a-n.

The memory system 110 also includes configuration structures 352. The configuration structures 352 may include information such as configuration descriptors for boot enable (bBootEnable), initial power mode (bInitPowerMode), RPMB active (bRPMBRegionEnable), and/or RPMB region sizes (bRPMBRegion1 Size, bRPMBRegion2Size, bRPMBRegion3Size). Configuration structures 352 may further include a configuration descriptor for a current level attribute (bActiveICCLevel) for setting a maximum current consumed by the memory system 110 or one or more components of the memory system. As another example, configuration structures 352 may include configuration descriptors for enabling exception event status bits (bActiveICCLevelChangeStart_EN and bActiveICCLevelChangeCompleted_EN) for suspending and resuming background operations on a memory system. Such configuration structures and/or parameters may, for example, be configuration structures and/or parameters identified by the UFS standard.

The host device 102 may be configured to execute one or more applications 334, such as user applications executed by an operating system under the control of a user to receive user input and provide information stored in the memory system 110 to the user. The host device 102 may include several components for interfacing the application 334 to the memory system 110 through the memory interface 310. For example, a SCSI driver 332 and a UFS driver 330 may interface the application 334 to a host memory controller that includes the data link layer block 314 and the physical layer access block 312. The SCSI driver 332 may execute at an application layer for handling transactions requested by the application 334 with the memory system 110. The UFS driver 330 may execute at a transport layer and manage operation of the data link layer block 314, such as to operate the memory interface 310 at one of a plurality of modes of operations. The modes of operations may include two or more gear settings, such as one or more PWM-GEAR settings and four or more HS-GEAR settings specifying one bitrate from 182 MBps, 364MBps, 728 MBps, and 1457 MBps.

The memory interface 310 may include one or more lines including a reset RST line, a reference clock REF_CLK line, a data-in DIN line (for data transmissions from the host device 102 to the memory system 110), and a data-out DOUT line (for data transmissions from the memory system 110 to the host device 102). The DIN and DOUT lines may be two separate conductors, or the DIN and DOUT lines may include multiple conductors. In some embodiments, the DIN and DOUT lines may be asymmetric with the DIN line including N conductors and the DOUT line including M conductors, with N>M or M>N.

The UFS driver 330 may generate and decode packets to carry out transactions requested by the application 334. The packets are transmitted over the memory interface 310. The packets may be formatted as UFS Protocol Information Units (UPIUs). In a transaction with the memory system 110, the host device 102 is an initiator and the memory system 110 is a target. The UFS driver 330, based on the type of transaction, may form one of several types of UPIUs for handling SCSI commands, data operations, task management operations, and/or query operations. Each transaction may include one command UPIU, zero or more DATA IN or DATA OUT UPIUs, and a response UPIU. Each UPIU may include a header followed by optional fields depending on the type of UPIU.

One example transaction is a read operation. A read transaction may include the initiator (e.g., host device 102) transmitting a command UPIU for causing the target (e.g., memory system 110) to perform a read operation requested by the application 334. The target provides one or more DATA IN UPIUs in response to the command UPIU, in which the DATA IN UPIUs include the requested data. The read transaction is completed by the target transmitting a Response UPIU.

Another example transaction is a write operation. A write operation may include the initiator (e.g., host device 102) transmitting a command UPIU for causing the target (e.g., memory system 110) to perform a write operation requested by the application 334. The target provides a Ready to Transfer UPIU signaling the initiator to begin transfer of write data. The initiator then transmits one or more DATA OUT UPIUs, which are followed by a Ready to Transfer UPIU signaling the initiator to continue transfer of the write data. The sequence of DATA OUT UPIUs and Ready to Transfer UPIU continues until all write data is provided to the target, after which the target provides a Response UPIU to the initiator.

A further example transaction is a query operation. A query operation may include the initiator (e.g., host device 102) requesting information about the target (e.g., memory system 110). The initiator may transmit a Query Request UPIU to request information such as configuration, enumeration, device descriptor, flags, and/or attributes of the target. Example query operations includes read descriptor, write descriptor, read attribute, write attribute, read flag, set flag, clear flag, and/or toggle flag. Example descriptors include device, configuration, unit, interconnect, string, geometry, power, and/or device health. Example flags include fDeviceInit, fPermanenetWPEn, fPowerOnWPEn, fBackgroundOpsEn, fDeviceLifeSpanModeEn, bActiveICCLevelChangeStart, bActiveICCLevelChangeCompleted, fPurgeEnable, fRefreshEnable, fPhyResourceRemoval, fBusyRTC, and/or fPermanentlyDisableFwUpdate. Example attributes include bBootLunEn, bCurrentPowerMode, bActiveICCLevel, bOutOfORderDataEn, bBackgroundOpStatus, bPurgeStatus, bMaxDataInSize, bMaxDataOutSize, dDynCapNeeded, and/or bRefClkFreq. Such flags may, for example, be flags identified by the UFS standard.

The operations and capabilities described above may be used for a memory system that supports queued current level adjustment in a flash memory system. For example, the operations and capabilities described above may be used for storing a pending current level change request for a memory system until a command queue for the memory system is empty and/or suspending one or more background operations being performed on a memory system to allow for adjustment of a current level of the memory system in accordance with such a request before the one or more background operations are complete.

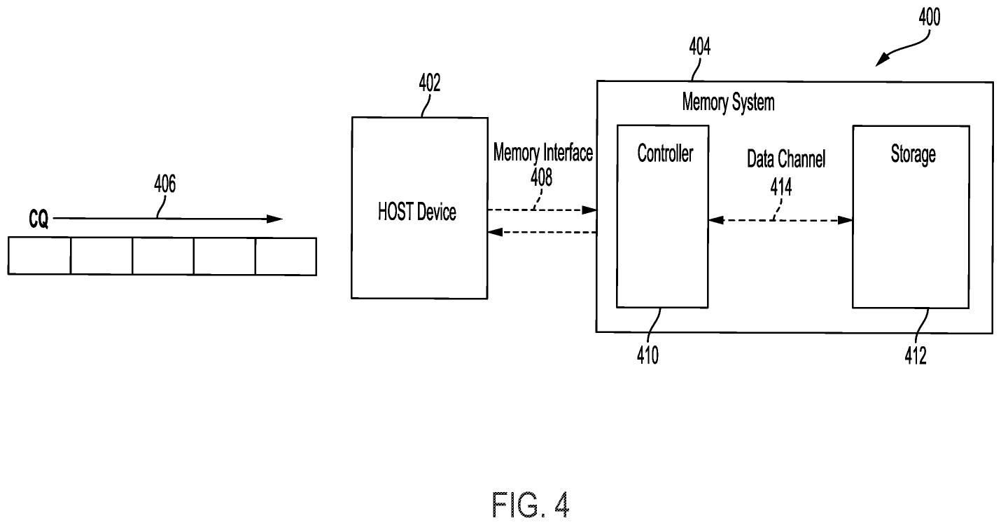

An example system 400 including a host device 402 and a memory system 404 is shown in FIG. 4. In some embodiments, the memory system 404 may be included in a host device 402. The host device 402 may communicate with the memory system 404 via a memory interface 408. The memory interface 408 may, for example, include one or more channels configured for transmission control data, such as one or more control channels. The memory interface 408 may be further configured for transmission of other data in addition to control data via the same channel as control data and/or via one or more other channels. In some embodiments, the memory interface 408 may be configured to support communication between the host device 402 and the memory system 404 through at least one of various interface protocols such as universal serial bus (USB), multimedia card (MMC), peripheral component interconnect express (PCI-e), serial attached SCSI (SAS), serial advanced technology attachment (SATA), parallel advanced technology attachment (PATA), small computer system interface (SCSI), enhanced small disk interface (ESDI), and integrated drive electronics (IDE). A command queue 406, which may be included in the memory system 404 and/or the host device 402 may store one or more operations to be performed on the memory system 404, such as one or more data reading or data writing operations. The memory system 404 may include a controller 410, such as a memory controller and a storage 412. The controller 410 may be connected to the storage 412 via one or more data channels 414 to store data in the storage 412 and/or access data stored in the storage 412. The controller 410 may also control the storage 412 through transmission of control data over the data channel 414. The storage 412 may, for example, include normal storage, such as triple-level cell (TLC) storage. The storage 412 may, in some embodiments, include one or more registers associated with the memory system 404, as described herein. In some embodiments, the system 400 may be configured to operate according to the UFS standard, and the memory system 404 may be a UFS memory system.

The memory system 404 may be configured to operate in a variety of power modes, such as power modes identified by the UFS standard. For example, the memory system 404 may be configured to operate in an active power mode when the memory system 404 is responding to a command from the host device 402 or is performing one or more background operations. A maximum current consumption of the memory system 404 may be adjustable, such as by a request to adjust a current of the memory system 404. For example, a bActiveICCLevel attribute stored in a register of the memory system 404 may be adjusted to adjust a maximum current consumption of the memory system 404. The bActiveICCLevel attribute may, for example, be set to a value from 0 to 15, with each value corresponding to a different current level. 0 may correspond to a lower maximum current level while 15 may correspond to a higher maximum current level. In some embodiments, different maximum current level for different power supplies may be set, such as using wActiveICCLevelsVCC, wActiveICCLevelsVCCQ, and wActiveICCLevelsVCCQ2 attributes based on the bActiveICCLevel attribute. In some embodiments, current consumption values associated with each value of the bActiveICCLevel attribute may be stored in a power parameters descriptor of the memory system 404 and may be read by the host device 402 to determine a bActiveICCLevel value that corresponds to a desired maximum current level, such as a maximum current level that will provide a best performance while remaining within current limitations of one or more power supplies of the host device.

The memory system 404 may transition between various power states during operation. For example, the memory system 404 may be battery powered, directly connected to an external power source, or otherwise powered. In some embodiments, while the memory system is directly connected to the external power source, the memory system may operate off battery power and the battery may be directly connected to the external power source. As another example, a battery of the memory system 404 may enter a low charge or failing state. Changes in power supply and/or battery status may prompt a host device 402 to adjust a current level of the memory system 404, such as to provide enhanced performance when a battery is fully charged and/or the memory system 404 is connected to an external power source, or to conserve battery life, when the battery is in a low charge or failing state. Other scenarios may also exist that may prompt the host device 402 to adjust a current level of the memory system 404, such as a current level of a memory module, such as storage 412, of the memory system 404. In some embodiments, a bActiveICCLevel for the memory system 404 may be set to 06 h when powered by a battery and 0 Ch when connected to an external power supply.

If a request to adjust a current level of the memory system 404, such as a request to set the bActiveICCLevel of the memory system 404, is received by the memory system 404 while the command queue 406 is empty and, in some embodiments, while no background operations are being performed on the memory system 404, the memory system 404 may adjust the current level of the memory system 404 in accordance with the received request, such as by increasing or decreasing the current level of the memory system. When the current level of the memory system has been adjusted, the memory system 404 may transmit a response to the host, such as an ACK/NACK message. As described herein, a current level of a memory system 404 may refer to a maximum current level of the memory system 404.

In some configurations, a request to adjust a current level of the memory system 404, such as a request to set the bActiveICCLevel of the memory system 404, may be discarded if the request is received while one or more operations are pending in a command queue associated with the memory system 404 and/or while one or more background operations are being performed on the memory system 404. For example, a request to adjust a current level of the memory system 404 is received by the memory system 404 from the host device 402 while the command queue 406 includes one or more commands. For example, such a request may be transmitted to reduce a current level of the memory system 404, such as when the memory system 404 is disconnected from a power supply and begins operating off battery power without an external power supply to charge the battery. As another example, such a request may be transmitted to increase a current level of the memory system 404, such as to provide enhanced performance when the memory system is connected to an external power supply. In response to receipt of such a request, the memory system 404 may transmit a notification, such as a notification including a Query Response field set to General Failure or another failure notification, to the host device 402 and may discard the request. Such operation may, for example, be operation as identified with respect to receipt of a bActiveCCLevel request when one or more operations of a command queue are outstanding in the UFS standard. Discarding the request and transmitting a failure notification to the host device 402 may require retransmission of the request, and may delay implementation of a requested adjustment to current level of the memory system 404. Such retransmission and delay may increase latency in the system 400 and may result in lower battery life and/or reduced performance. In some cases, discarding the request to adjust the current level may cause the device to operate in a higher current state for a period of time even when a charge level of a battery of the memory system 404 is very low, which may cause charge of the battery to be depleted, requiring a shutdown of memory system 404. For example, delay of implementation of a request to increase a current level of the memory system 404 may cause the memory system 404 to operate in a reduced performance and current consumption mode until the request is implemented when the memory system 404 is connected to an external power supply and has sufficient power to operate at the increased current level.

The memory system 404 may include a register, such as a request queue register, in storage 412 or another memory associated with the memory system 404, to store an indication of a request to adjust a current level of the memory system when the request is received while one or more operations of the memory system 404 are outstanding, such as when the command queue 406 includes one or more logical units that are not empty. Such a register may allow the memory system 404 to store a current level adjustment request until a determination is made that the command queue 406 is empty, such as until the memory system 404 is about to transition from an active mode to an idle mode. For example, the memory system 404 may receive a request to adjust a current level of the memory system 404, such as a request to set the bActiveICCLevel of the memory system 404 to a particular value. The memory system 404 may determine that the command queue 406 is not empty, and may store an indication of the request in a register. Such a register may, for example, be a queue, such as a bActiveICCLevelemdqueue. The register may include one or more bits for indicating that a bActiveICCLevel request indication is stored therein, one or more bits for storing the bActiveICCLevel request inication, and/or one or more reserved bits. The memory system 404 may notify the host device 402 that the request is pending. Then, when the command queue 406 is empty, the memory system may adjust the current level according to the request indication stored in the register and may notify the host device 402 that the current level has been adjusted.

As another example, the host device 402 may hold a request to adjust a current level of the memory system 404, such as a request to set the bActiveICCLevel of the memory system 404, in a queue of the host device 402. Then, when the command queue 406 is empty, the host device 402 may transmit the request to the memory system 404. Furthermore, the memory system 404 may determine whether one or more background operations are being performed on the memory system 404, upon receipt of the request to adjust the current level. If one or more background operations are not being performed on the memory system 404, the memory system 404 may adjust the current level according to the request. However, if one or more background operations are being performed, the memory system 404 may notify the host device 402 to suspend the one or more background operation. Upon receipt of the notification, the host device 402 may suspend the background operations, and the memory system 404 may adjust the current level of the memory system 404 in accordance with the received request. Once the current level of the memory system 404 has been adjusted, the memory system 404 may notify the host device 402 that the current level has been adjusted. The host device 402 may then resume the background operations. Thus, in some embodiments, a request to adjust a current level of a memory system 404 may be held by the host device 402 until the command queue 406 is empty, and the memory system 404 may notify the host device 402 to suspend one or more background operations to allow the memory system 404 to adjust the current level of the memory system 404 according to the request.

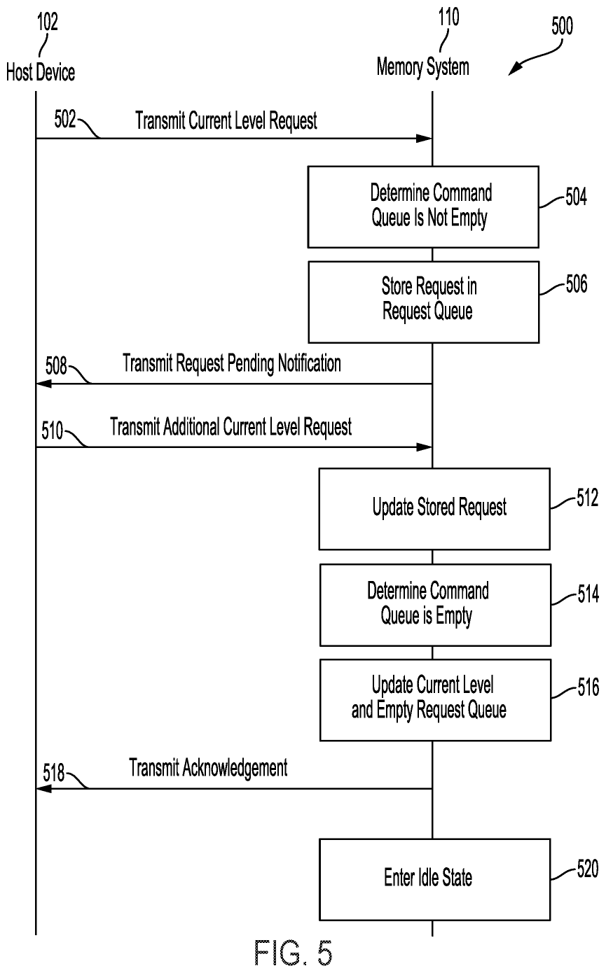

An example call diagram 500 for queued current level adjustment is shown in FIG. 5. A host device, such as host device 102, may communicate with a memory system 110 to adjust a current level of the memory system 110. The memory system 110 may be a flash memory system configured to operate according to the UFS standard, as described herein. In some embodiments, the memory system 110 may be included in the host device 102, while in other embodiments, the memory system 110 may be otherwise connected to the host device 102. According to the operations described with respect to FIG. 5, a request to adjust a current level of the memory system 110 may be stored in a request queue register of the memory system 110 until a command queue of the memory system 110 is empty.

At message 502, the host device 102 may transmit a current level request to the memory system 110. For example, the host device 102 may determine that a state of power supplied to the host device 102 and/or the memory system 110 has changed. For example, the host device 102 may determine that the host device 102 and/or the memory system 110 has been disconnected or connected to an external power supply. The current level request may thus be a request to increase or decrease a maximum current level of the memory system 110. In some embodiments, the current level request may, for example, include a bActiveICCLevel request, with a value of 06 h, 0 Ch, or another value. For example, the request may be a bActiveICCLevel command. A value of 06 h may, for example, be used to adjust a maximum current level of the memory system 110 for operation using battery power, while a value of 0 Ch may be used to adjust the maximum current level of the memory system 110 for operation when the battery and/or the memory system is connected to an external power supply. In some embodiments, the current level request may be received by the memory system 110 while the memory system is in an active power mode.

At block 504, the memory system 110 may determine that a command queue associated with the memory system 110 is not empty. For example, a command queue may store one or more pending operations requested by the host device 102 for performance on the memory system 110. In some embodiments, the command queue may be stored in a register of the memory system 110. If the command queue is determined to be empty, the memory system 110 may proceed to update the current level in accordance with the request, as described with respect to block 516.

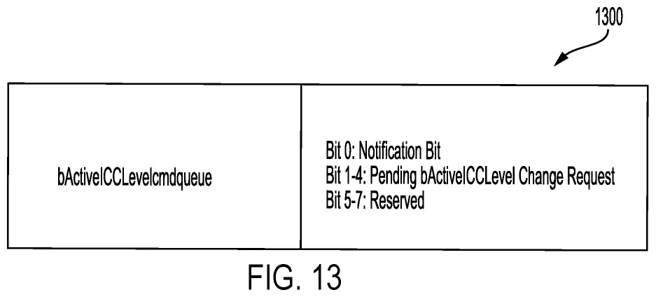

At block 506, the memory system may store an indication of the request in a request queue, such as in a register of the memory system 110. The register may, for example, be a bActiveICCLevelcmdqueue. The register may, for example, be 8 bits, or greater or fewer than 8 bits. In some embodiments, the register may be a register as described with respect to FIG. 13. The request queue may include a first bit for indicating whether an indication of a request to adjust a current level of the memory system 110 is stored in the request queue. The request queue may include additional bits, such as four bits, for storing the indication of the request, such as for storing the request itself and/or a hexadecimal value indicating the requested current level change. The request queue may also include one or more reserved bits. Thus, for example, in response to receipt of the request and a determination that the command queue is not empty, an indication of the current level request, such as a binary equivalent of a hexadecimal value of the current level request indicating a requested current level, may be stored in in the second through fifth bits of the register.

At message 508, the memory system 110 may transmit a notification that the request is pending to the host device. Such a notification may, for example, a pending or awaiting notification and may include an indication of the current level request with which the notification is associated.

In some embodiments, additional current level requests may be transmitted by the host device 102 and received by the memory system 110 before a current level of the memory system 110 is adjusted. For example, at message 510 an additional current level request may be transmitted by the host device 102 and received by the memory system 110. At block 512, the memory system 110 may update the stored request in accordance with the additional current level request. For example, the memory system 110 may overwrite the indication of the first received current level request in the register with the indication of the new current level request. In some embodiments, if a current level request is overwritten in the register before a current level of the memory system 110 is adjusted in accordance with the current level request, a non-acknowledgement (NACK) message may be transmitted by the memory system to the host device 102, and the NACK message may indicate the earlier transmitted request to adjust the current level was not implemented.

At block 514, the memory system 110 may determine that the command queue is empty. For example, when a command queue associated with the memory system 110 is empty, such as when there are no outstanding operations for the memory system and/or all logical units of the command queue are empty, the memory system 110 may determine whether a bit indicating whether a request to update a current level of the memory system 110 has been stored in the request queue is set to 1. In some embodiments, such a determination may be made before the memory system 110 enters an idle mode.

When the command queue is empty and an indication of a request to adjust a current level of the memory system 110 is stored in the request queue, the memory system 110 may, at block 516, update the current level of the memory system 110 in accordance with the stored request. For example, the memory system 110 may increase or decrease a maximum current consumption of the memory system. After the current level has been adjusted in accordance with the stored indication of the request, the memory system may empty the request queue. For example, the memory system 110 may toggle a bit of the request queue register indicating whether a request is stored in the request queue to 0 and may reset the bits of the register allocated for storage of the indication of the request to 0as well.

At block 518, the memory system 110 may transmit an acknowledgement to the host device 102 indicating that the request to adjust the current level of the memory system 110 has been implemented. Such an acknowledgement may, for example be transmitted to a controller of the host device 102. At block 520, the memory system 110 may enter an idle state. For example, after an acknowledgement to the current level request is transmitted at 518, if no operations are pending in the command queue, the memory system 110 may enter a low power or idle state.

An example call diagram 600 for queued current level adjustment is shown in FIG. 6. A host device, such as host device 102, may communicate with a memory system 110 to adjust a current level of the memory system 110. The memory system 110 may be a flash memory system configured to operate according to the UFS standard, as described herein. In some embodiments, the memory system 110 may be included in the host device 102, such as in a SOC, while in other embodiments, the memory system 110 may be otherwise connected to the host device 102. According to the operations described with respect to FIG. 6, a request may be held by the host device 102, until a command queue associated with the memory system 110 is empty, and the memory system 110 may request that the host device suspend background operations on the memory system 110 when a request to adjust a current level of the memory system 110 is received.

At block 602, the host device 102 may generate and/or receive a current level request. The request may, for example, include a bActiveICCLevel request, such as a bActiveICCLevel command, as described herein. For example, the request may be a request similar to the request described with respect to message 502 of FIG. 5.

At block 604, the host device may determine that a command queue associated with the memory system 110 is not empty and may hold the request. For example, the host device 102 may determine that one or more operations to be performed on the memory system 110 are pending in the command queue. The command queue may, for example, be located on the host device 102, the memory system 110, or on another device. The request may, for example, be a bActiveICCLevelChange request and may be held in a wait queue of the host device for processing when the command queue becomes empty. If the host device determines that the command queue is empty, the host device 102 may proceed to transmit the current level request to the memory system 110.

At block 606, the host device may determine that the command queue is empty. At message 608, the host device may transmit the current level request that was held in the wait queue of the host device 102 to the memory system 110.

At block 610, the memory system 110 may determine that one or more background operations are being performed or are queued to be performed on the memory system 110. Such a determination may, for example, be performed in response to receipt of the current level request in message 608. In some embodiments, if no background operations are currently being performed on the memory system 110 by the host device and/or if no background operations are queued to be performed on the memory system 110, the memory system may proceed to update the current level of the memory system 110 in accordance with the received request.

When background operations are determined to be in progress on the memory system 110 at block 610, the memory system 110 may update a register to notify the host device 102 to suspend the one or more background operations. For example, the memory system 110 may update one or more bits of an exception event register, such as a wExceptionEventControl register, to indicate that the host device 102 should suspend one or more background operations. For example, updating the register at block 612 may include toggling a bit of the wExceptionEventControl register, such as setting an eighth bit of the wExceptionEventControl register to 1. The eighth bit of the wExceptionEventControl register may, for example, be a bActiveICCLevelChangeStart bit which, when set to 1, may notify the host device 102 to suspend one or more background operations so that the memory system 110 can implement the current level request.

At message 614, the memory system 110 may notify the host device 102 that one or more background operations performed by the host device 102 on the memory system 110 should be suspended. For example, the memory system 110 may notify the host device 102 that the bit of the register indicating that the host device 102 should suspend background operations of the memory system 110 has been set. For example, the memory system 110 may generate an exception event, such as a wExceptionEvent by setting the bActiveICCLevelChangeStart bit to 1 and may transmit, at message 614, such an exception event to the host device 102. At block 616, the host device 102 may suspend the one or more background operations in response to receipt of the suspension notification.

At block 618, the memory system 110 may adjust a current level of the memory system 110 in accordance with the received current level request and may update the register. For example, the memory system 110 may update the current level of the memory system in accordance with the received current level request similarly to updating the current level at block 516 of FIG. 5. After updating the current level in accordance with the received current level request, the memory system 110 may update the register to indicate that the current level of the memory system 110 has been updated in accordance with the request. For example, the memory system 110 may reset the bit of the register, such as the bActiveICCLevelChangeStart bit of the wExceptionEvent register to 0. Alternatively or additionally, the memory system 110 may update a different bit of the register to indicate that the update has been applied. For example, a bit of the wExceptionEvent register, such as a ninth bit of the wExceptionEvent register, may be reserved for indicating whether the current level has been adjusted in accordance with a received current level request. The ninth bit of the wExceptionEvent register may, for example, be a bActiveICCLevelChangeCompleted bit, which may be set to 1 at block 618, in response to updating of the current level of the memory system 110 in accordance with the received current level request. Setting of such a bit may, for example, generate a wExceptionEvent notification with bActiveICCLevelChangeCompleted set to 1, which may be transmitted to the host device 102 at message 620 to notify the host device 102 to resume the one or more suspended background operations. Then, at block 622, the host device 102 may, in response to the received notification, resume the one or more suspended background operations on the memory system 110. Thus, background operations may be suspended to allow for adjustment of a current level of a memory system in accordance with a received current level request before background operations are completed.

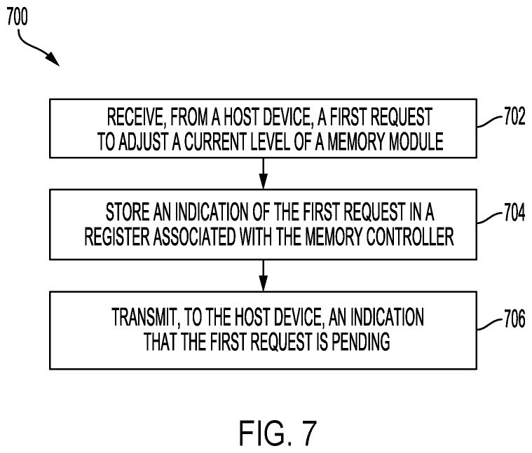

FIG. 7 is flow chart illustrating a method for queued current level adjustment by a flash memory system according to some embodiments of the disclosure. A method 700 includes, at block 702, receiving, from a host device by a memory controller of a memory system, a first request to adjust a current level of a memory module of the memory system. The first request may, for example, be a request to adjust a current level of the memory system or one or more components of the memory system. The first request may, for example, include a bActiveICCLevel command indicating a requested current level. The request may, for example, include a hexadecimal value corresponding to a requested current level, such as 06 h, 0 Ch, or another value. In some embodiments, the current level request may be received by the memory system while the memory system is in an active power mode. The memory module may, for example, comprise a flash memory device configured as a UFS device.

At block 704, the memory controller may store the indication of the first request in a register associated with the memory controller of the memory system. The register may, for example, be a request queue, such as a bActiveICCLevelcmdqueue register. In some embodiments, the register may be an 8 bit register, such as the register described with respect to FIG. 13. In some embodiments, the indication of the request may be stored in the register based upon receipt of the request to adjust the current level and a determination that a command queue associated with the memory controller includes one or more commands. Storage of the indication of the request in the register may, for example, include toggling a bit of the register, such as a first bit of the register, to indicate that the request is stored in the register. Storage of the indication of the request in the register may further include storing the pending request, such as the bActiveICCLevel command, in the register, such as in second through fifth bits of the register. For example, a binary value corresponding to a hexadecimal value of the request indicating the current level may be stored in the second through fifth bits of the register. The sixth through eighth bits of the register may be reserved. In some embodiments, an additional request to adjust a current level of the memory module may be received subsequent to storage of the indication of the first request in the register. If the current level of the memory module has not yet been adjusted in accordance with the received first indication, the memory controller may update the stored indication of the first request to adjust the current level in accordance with the received additional request. For example, the indication of the first request may be overwritten with an indication of the second request. When the indication of the first request is overwritten, the memory controller may notify the host device that the current level of the memory module was not adjusted in accordance with the first request. For example, the memory controller may transmit a non-acknowledgement (NACK) message associated with the first request to the host device.

At block 706, the memory controller may transmit, to the host device, an indication that the received first request is pending. For example, the memory controller may transmit a response to the first request including a pending or awaiting indication in response to the received request. Thus, a memory controller may store an indication of a received request to adjust a current level of a memory module in a register and may notify a host device from which the request was received that the request is pending.

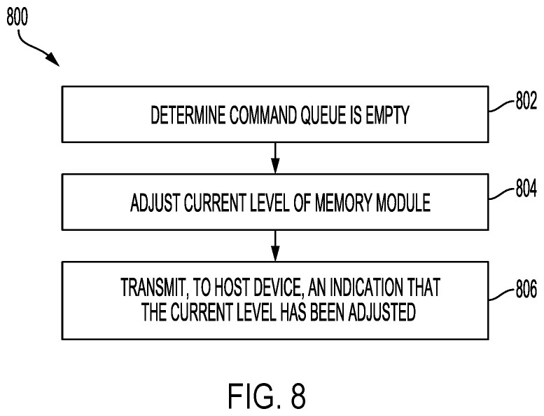

FIG. 8 is flow chart illustrating a method for queued current level adjustment by a flash memory system according to some embodiments of the disclosure. One or more blocks of the method 800 of FIG. 8 may be performed along with the operations described with respect to FIG. 7 or other operations described herein. A method 800 includes, at block 802, determining, by a memory controller that a command queue is empty. For example, after storing an indication of a first request to adjust a current level, such as described with respect to block 704 of FIG. 7, the operations stored in the command queue may be completed and the command queue may be empty. The memory controller may, for example, determine that no operations are pending in the command queue. The memory module may, for example, comprise a flash memory device configured as a UFS device.

At block 804, the memory controller may adjust a current level of the memory module in accordance with a stored indication of a received request to adjust a current level of the memory module. For example, the memory controller may, upon a determination that the command queue is empty, determine if a first bit of a register for storing pending current level adjustment requests is set to indicate that an indication of a pending current level adjustment request is stored therein. If the first bit indicates that an indication of a pending current level adjustment request is stored in the register, the memory controller may read the stored indication of the pending current level adjustment request from the register and may adjust a current level of the memory module in accordance with the request. In some embodiments, adjusting the current level of the memory module in accordance with the stored indication of the request may include increasing a maximum current consumption or decreasing a maximum current consumption of the memory module and/or the memory system.

At block 806, the memory controller may transmit, to the host device, an indication that the current level has been adjusted. Such an indication may, for example, include an acknowledgement to a request to adjust the current level of the memory module received by the memory controller from the host device. Thus, when a command queue is empty, a pending request to adjust a current level of a memory module may be implemented, and a host device may be notified of implementation of the request.

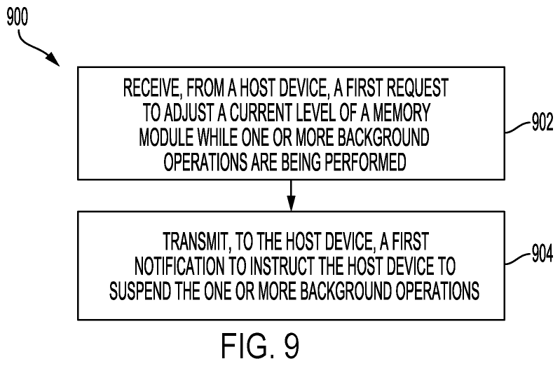

FIG. 9 is flow chart illustrating a method for queued current level adjustment by a flash memory system according to some embodiments of the disclosure. A method 900 includes, at block 902, receiving, by a memory controller of a memory system from a host device, a first request to adjust a current level of a memory module of the memory system while one or more background operations are being performed on the memory module by the host device. The first request may, for example, include a bActiveICCLevel command, as discussed herein. The memory module may, for example, comprise a flash memory device configured as a UFS device.

At block 904, the memory controller may transmit, to the host device, a first notification to instruct the host device to suspend the one or more background operations. Such a notification may, for example, include an exception event notification. For example, the memory controller may toggle a bit of an exception event register, such as an eighth bit of a wExceptionEventStatus register, to indicate that the host device should suspend the one or more background operations. Such a bit may, for example, be a bActiveICCLevelChangeStart bit, and toggling the bit may include setting the bit to 1. Toggling the bit may trigger transmission of an exception event notification to the host device notifying the host device that the bActiveICCLevelChangeStart bit has been set. Thus, the memory controller may receive, from a host device, a request to adjust a current level of a memory module while one or more background operations are being performed on the memory module and may notify the host device to suspend the one or more background operations.

In some embodiments, the memory controller may toggle bits of a register, such as eighth and/or ninth bits of a wExceptionEventControl register, to enable bits of the wExceptionEventStatus register, such as the bActiveICCLevelChangeStart and bActiveICCLevelChangeCompleted bits of the wExceptionEventStatus register, for indicating whether background operations on the memory module should be suspended or resumed. In some embodiments, the memory controller may check such bits to determine whether the bActiveICCLevelChangeStart and bActiveICCLevelChangeCompleted bits of the wExceptionEventStatus register are enabled before toggling the bActiveICCLevelChangeStart and bActiveICCLevelChangeCompleted bits of the wExceptionEventStatus register.

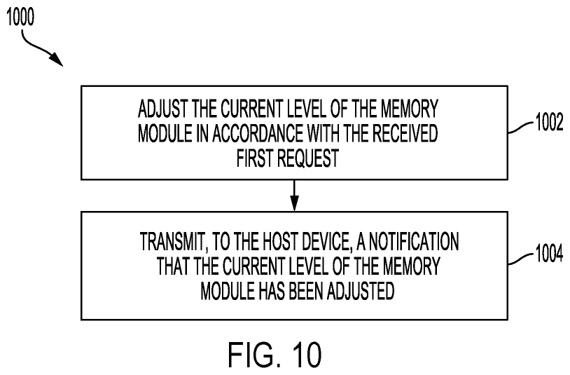

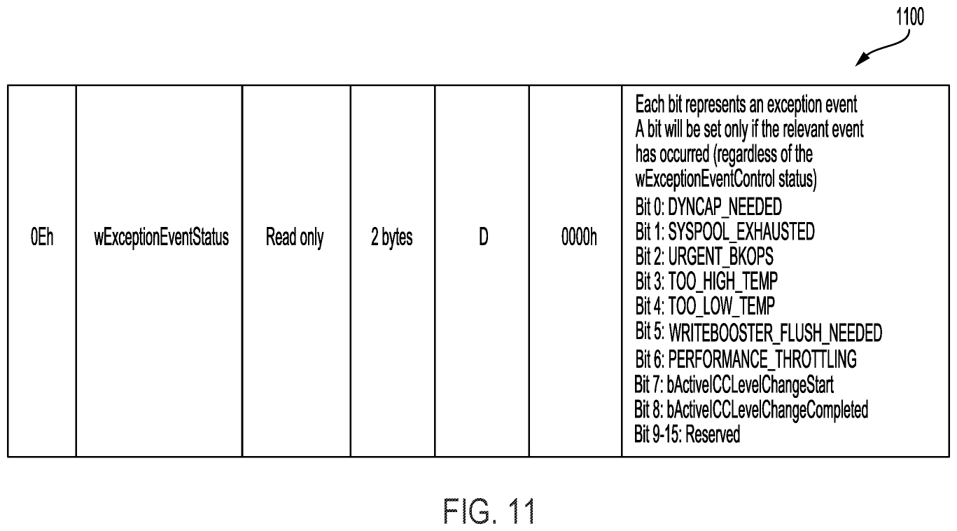

FIG. 10 is flow chart illustrating a method for queued current level adjustment by a flash memory system according to some embodiments of the disclosure. One or more blocks of the method 1000 of FIG. 10 may be performed along with the operations described with respect to FIG. 10 or other operations described herein. A method 1000 includes, at block 1002, adjusting a current level of the memory module in accordance with a received request. For example, such adjustment may be performed in accordance with the request received at block 902 of FIG. 9 after the host device suspends performance of one or more background operations on the memory module. For example, a current level of the memory module and/or memory system may be increased or decreased in accordance with the received request to adjust the current level as described herein.

At block 1004, a second notification that the current level of the memory module has been adjusted may be transmitted to the host device. For example the second notification may be transmitted after adjusting the current level of the memory module in accordance with the received request. Such a notification may, for example, include an exception event notification. For example, the memory controller may toggle a bit of an exception event register, such as a ninth bit of a wExceptionEventStatus register, to indicate that the host device should resume the one or more background operations. Such a bit may, for example, be a bActiveICCLevelChangeCompleted bit, and toggling the bit may include setting the bit to 1. Toggling the bit may trigger transmission of an exception event notification to the host device notifying the host device that the bActiveICCLevelChangeCompleted bit has been set. The second notification may therefore be a bActiveICCLevelChangeCompleted notification. Thus, the memory controller may adjust a current level of a memory module in accordance with a received request and may notify a host device to resume background operations after the current level has been adjusted.

An example layout 1100 of a wExceptionEventStatus register is shown in FIG. 11. The wExceptionEventStatus register may include two bytes, and each bit of the wExceptionEventStatus register may correspond to an exception event. Thus, one or more bits of the wExceptionEventStatus register may be set when an exception event occurs. For example, an eighth bit of the wExceptionEventStatus register may be associated with a bActiveICCLevelChangeStart event, as discussed herein, and a ninth bit of the wExceptionEventStatus register may be associated with a bActiveICCLevelChangeCompleted event, as discussed herein. Bits 10-16 of the wExceptionEventStatus register may be reserved. The wExceptionEventStatus register and various exception events may correspond to the wExceptionEventStatus register and events identified by the UFS standard. In some embodiments, the wExceptionEventStatus register may be stored in a memory associated with a memory controller of a flash memory system.

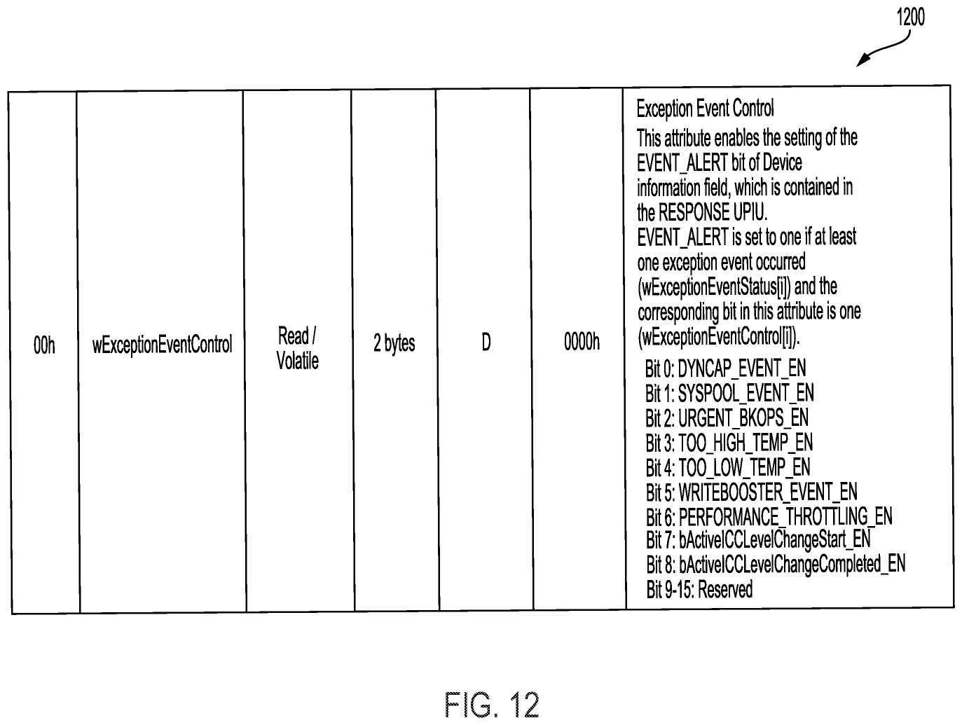

An example layout 1200 of a wExceptionEventControl register is shown in FIG. 12. The wExceptionEventControl register may include two bytes, and each bit of the wExceptionEventControl register may correspond to enablement of one or more exception event alerts. Thus, one or more bits of the wExceptionEventControl register may be set to 1 to enable indication of one or more exception events by the bits of the wExceptionEventStatus register. For example, an eighth bit of the wExceptionEventControl register may be associated with a bActiveICCLevelChangeStart_EN parameter, which may enable a bActiveICCLevelChangeStart bit of the wExceptionEventStatus register, as described herein. Likewise, a ninth bit of the wExceptionEventControl may be associated with a bActiveICCLevelChangeCompleted_EN parameter, which may enable a bActiveICCLevelChangeCompleted bit of the wExceptionEventStatus register, as discussed herein. Bits 10-16 of the wExceptionEventControl register may be reserved. The wExceptionEventControl register and various exception events may correspond to the wExceptionEventControl register and events identified by the UFS standard. In some embodiments, the WexceptionEventControl register may be stored in a memory associated with a memory controller of a flash memory system.

An example layout 1300 of a bActiveICCLevelemdqueue register, as discussed herein, is shown in FIG. 13. The bActiveICCLevelemdqueue register may include one byte. A first bit of the bActiveICCLevelemdqueue register may be a notification bit and may be set to 1 to indicate that an indication of a received current level adjustment request is stored in the queue. Bits 2-5 of the bActiveICCLevelcmdqueue register may be allocated for storage of an indication of a received current level adjustment request. For example, such bits may be used to store a binary number corresponding to a received hexadecimal value of a received current level adjustment request, the hexadecimal value being associated with a requested maximum current level. Bits 6-8 of the bActiveICCLevelemdqueue register may be reserved. In some embodiments, the bActiveICCLevelcmdqueue register may be stored in a memory associated with a memory controller of a flash memory system.

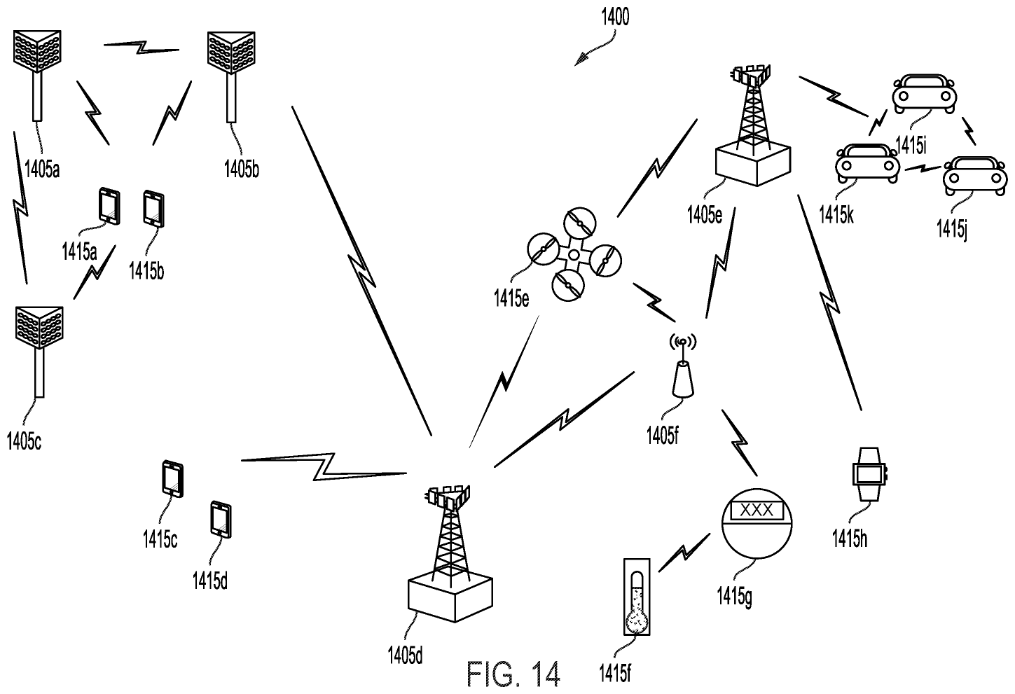

Operations of method 700, method 800, method 900, or method 1000 may be performed by a UE, such as a UE described with reference to FIG. 14. For example, example operations (also referred to as “blocks”) of method 700, method 800, method 900, or method 1000 may enable UE 1415 to support greater user data confidentiality. FIG. 14 is a block diagram illustrating details of an example wireless communication system according to one or more aspects. The wireless communication system may include wireless network 1400. Wireless network 1400 may, for example, include a 5G wireless network. As appreciated by those skilled in the art, components appearing in FIG. 14 are likely to have related counterparts in other network arrangements including, for example, cellular-style network arrangements and non-cellular-style-network arrangements (e.g., device to device or peer to peer or ad hoc network arrangements, etc.).

Wireless network 1400 illustrated in FIG. 14 includes a number of base stations 1405 and other network entities. A base station may be a station that communicates with the UEs and may also be referred to as an evolved node B (eNB), a next generation eNB (gNB), an access point, and the like. Each base station 1405 may provide communication coverage for a particular geographic area. In 3GPP, the term “cell” may refer to this particular geographic coverage area of a base station or a base station subsystem serving the coverage area, depending on the context in which the term is used. In implementations of wireless network 1400 herein, base stations 1405 may be associated with a same operator or different operators (e.g., wireless network 1400 may include a plurality of operator wireless networks). Additionally, in implementations of wireless network 1400 herein, base station 1405 may provide wireless communications using one or more of the same frequencies (e.g., one or more frequency bands in licensed spectrum, unlicensed spectrum, or a combination thereof) as a neighboring cell. In some examples, an individual base station 1405 or UE 1415 may be operated by more than one network operating entity. In some other examples, each base station 1405 and UE 1415 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic arca and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 14, base stations 1405d and 1405e are regular macro base stations, while base stations 1405a-1405c are macro base stations enabled with one of 3 dimension (3D), full dimension (FD), or massive MIMO. Base stations 1405a-1405c take advantage of their higher dimension MIMO capabilities to exploit 3D beamforming in both elevation and azimuth beamforming to increase coverage and capacity. Base station 1405f is a small cell base station which may be a home node or portable access point. A base station may support one or multiple (e.g., two, three, four, and the like) cells.

Wireless network 1400 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 1415 are dispersed throughout the wireless network 1400, and each UE may be stationary or mobile. It should be appreciated that, although a mobile apparatus is commonly referred to as a UE in standards and specifications promulgated by the 3GPP. such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology. Within the present document, a “mobile” apparatus or UE need not necessarily have a capability to move, and may be stationary. Some non-limiting examples of a mobile apparatus, such as may include implementations of one or more of UEs 1415, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an IoT or “Internet of everything” (IoE) device such as an automotive or other transportation vehicle, a satellite radio, a global positioning system (GPS) device, a global navigation satellite system (GNSS) device, a logistics controller, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc.; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 1415a-1415d of the implementation illustrated in FIG. 14 are examples of mobile smart phone-type devices accessing wireless network 1400. A UE may also be a machine specifically configured for connected communication, including machine type communication (MTC), enhanced MTC (eMTC), narrowband IoT (NB-IoT) and the like. UEs 1415c-1415k illustrated in FIG. 14 are examples of various machines configured for communication that access wireless network 1400.

A mobile apparatus, such as UEs 1415, may be able to communicate with any type of the base stations, whether macro base stations, pico base stations, femto base stations, relays, and the like. In FIG. 14, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 1400 may occur using wired or wireless communication links.

In operation at wireless network 1400, base stations 1405a-1405c serve UEs 1415a and 1415b using 3D beamforming and coordinated spatial techniques, such as coordinated multipoint (CoMP) or multi-connectivity. Macro base station 1405d performs backhaul communications with base stations 1405a-1405c, as well as small cell, base station 1405f. Macro base station 1405d also transmits multicast services which are subscribed to and received by UEs 1415c and 1415d. Such multicast services may include mobile television or stream video, or may include other services for providing community information, such as weather emergencies or alerts, such as Amber alerts or gray alerts.

Wireless network 1400 of implementations supports mission critical communications with ultra-reliable and redundant links for mission critical devices, such UE 1415e, which is a vehicle. Redundant communication links with UE 1415e include from macro base stations 1405d and 1405e, as well as small cell base station 1405f. Other machine type devices, such as UE 1415f (thermometer), UE 1415g (smart meter), and UE 1415h (wearable device) may communicate through wireless network 1400 either directly with base stations, such as small cell base station 1405f, and macro base station 1405e, or in multi-hop configurations by communicating with another user device which relays its information to the network, such as UE 1415f communicating temperature measurement information to the smart meter, UE 1415g, which is then reported to the network through small cell base station 1405f. Wireless network 1400 may also provide additional network efficiency through dynamic, low-latency TDD communications or low-latency FDD communications, such as in a vehicle-to-vehicle (V2V) mesh network between UEs 1415i-1415k communicating with macro base station 1405c.

In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks (sometimes referred to as “5G NR” networks, systems, or devices), as well as other communications networks. As described herein, the terms “networks” and “systems” may be used interchangeably. A CDMA network, for example, may implement a radio technology such as universal terrestrial radio access (UTRA). cdma2000, and the like. UTRA includes wideband-CDMA (W-CDMA) and low chip rate (LCR). CDMA2000 covers IS-2000, IS-95, and IS-856 standards. A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long-term evolution (LTE) is a release of UMTS that uses E-UTRA. The various different network types may use different radio access technologies (RATs) and RANs.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

In one or more aspects, techniques for supporting data storage and/or data transmission, may include additional aspects, such as any single aspect or any combination of aspects described below or in connection with one or more other processes or devices described elsewhere herein. In a first aspect, an electronic device, such as a UE, may be an apparatus as a host device that includes a memory controller configured to couple to an interface to a memory system, in which the memory system may be integrated with the host device or externally coupled to the host device. The memory system may include a memory controller coupled to a memory system through a data channel and configured to access data stored in the memory system through the data channel and coupled to a host device through a memory interface and configured to communicate with the host device over the memory interface. The operations may be executed as part of an initialization operation, a read operation or a write operation.

In a first aspect, the memory controller of the memory system may be configured to perform operations including receiving, from the host device, a first request to adjust a current level of the memory module, storing an indication of the first request in a register associated with the memory controller, and transmitting, to the host device, an indication that the first request is pending.

In a second aspect, in combination with the first aspect, the memory controller of the memory system may be configured to perform operations further including determining that a command queue associated with the memory controller includes one or more commands, wherein storing the indication of the first request in the register associated with the memory controller is performed in accordance with the determination that the command queue includes one or more commands.

In a third aspect, in combination with one or more of the first aspect or the second aspect, the memory controller of the memory system may be configured to perform operations further including determining, after transmitting the indication that the first request is pending, that the command queue is empty and adjusting the current level of the memory module in accordance with the stored indication of the first request and the determination that the command queue is empty.

In a fourth aspect, in combination with one or more of the first aspect through the third aspect, the memory controller of the memory system may be configured to perform operations further including transmitting, to the host device, an indication that the current level of the memory module has been adjusted, after adjusting the current level of the memory module.

In a fifth aspect, in combination with one or more of the first aspect through the fourth aspect, storing the indication of the first request comprises setting a first bit of the register to indicate that the indication of the first request is stored in the register.

In a sixth aspect, in combination with one or more of the first aspect through the fifth aspect, the first request comprises a bActiveICCLevel command.

In a seventh aspect, in combination with one or more of the first aspect through the sixth aspect, the memory controller of the memory system may be configured to perform operations further comprising receiving, from the host device, a second request to adjust the current level of the memory module while the indication of the first request is stored in the register and updating the stored indication of the first request in accordance with the second request.

In an eighth aspect, in combination with one or more of the first aspect through the seventh aspect, the memory controller of the memory system may be configured to perform operations further comprising transmitting, to the host device, an indication that the current level of the host device was not adjusted in accordance with the first request, after updating the stored indication of the first request in accordance with the second request.

In a ninth aspect, the memory controller of the memory system may be configured to perform operations including receiving, from the host device, a first request to adjust a current level of the memory module while one or more background operations are being performed on the memory module and transmitting, to the host device after receiving the first request, a first notification to instruct the host device to suspend the one or more background operations.

In a tenth aspect, in combination with the ninth aspect, the first notification comprises an exception event notification, and wherein transmitting the first notification comprises adjusting a bit of an exception event register associated with the memory controller in accordance with the received first request.

In an eleventh aspect, in combination with one or more of the ninth aspect through the tenth aspect, the exception event register comprises a wExceptionEventStatus register.

In a twelfth aspect, in combination with one or more of the ninth aspect through the eleventh aspect, the memory controller of the memory system may be configured to perform operations further comprising adjusting the current level of the memory module in accordance with the received first request after transmitting the first notification and transmitting, to the host device, a second notification that the current level of the memory module has been adjusted.

In a thirteenth aspect, in combination with one or more of the ninth aspect through the twelfth aspect, the second notification comprises an exception event notification, and wherein transmitting the second notification comprises adjusting a bit of an exception event register associated with the memory controller in accordance with the adjustment to the current level of the memory module.

In a fourteenth aspect, in combination with one or more of the ninth aspect through the thirteenth aspect, the memory module comprises a flash memory device configured as a universal flash storage (UFS) device.

In a fifteenth aspect, in combination with one or more of the ninth aspect through the fourteenth aspect, the first request comprises a bActiveICCLevel command.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-14 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill in the art that one or more blocks (or operations) described with reference to FIGS. 4-10 may be combined with one or more blocks (or operations) described with reference to another of the figures. For example, one or more blocks (or operations) of FIG. 1 may be combined with one or more blocks (or operations) of FIG. 3. As another example, one or more blocks associated with FIG. 1 may be combined with one or more blocks (or operations) associated with FIGS. 4-10. Additionally, or alternatively, one or more operations described above with reference to FIGS. 1-3 may be combined with one or more operations described with reference to FIGS. 4-10.

Those of skill in the art would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single-or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, which is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, opposing terms such as “upper” and “lower” or “front” and “back” or “top” and “bottom” or “forward” and “backward” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. An apparatus, comprising:
a memory controller:
coupled to a memory module through a data channel and configured to access data stored in the memory module through the data channel; and
coupled to a host device through a memory interface and configured to communicate with the host device over the memory interface,
the memory controller configured to perform operations comprising:
receiving, from the host device, a first request to adjust a current level of the memory module;
storing an indication of the first request in a register associated with the memory controller; and
transmitting, to the host device, an indication that the first request is pending.

2. The apparatus of claim 1, wherein the memory controller is further configured to perform operations comprising:
determining that a command queue associated with the memory controller includes one or more commands, wherein storing the indication of the first request in the register associated with the memory controller is performed in accordance with the determination that the command queue includes one or more commands.

3. The apparatus of claim 2, wherein the memory controller is further configured to perform operations comprising:
determining, after transmitting the indication that the first request is pending, that the command queue is empty; and
adjusting the current level of the memory module in accordance with the stored indication of the first request and the determination that the command queue is empty.

4. The apparatus of claim 3, wherein the memory controller is further configured to perform operations comprising:
transmitting, to the host device, an indication that the current level of the memory module has been adjusted, after adjusting the current level of the memory module.

5. The apparatus of claim 1, wherein storing the indication of the first request comprises setting a first bit of the register to indicate that the indication of the first request is stored in the register.

6. The apparatus of claim 1, wherein the first request comprises a bActiveICCLevel command.

7. The apparatus of claim 1, wherein the memory controller is further configured to perform operations comprising:
receiving, from the host device, a second request to adjust the current level of the memory module while the indication of the first request is stored in the register; and
updating the stored indication of the first request in accordance with the second request.

8. The apparatus of claim 7, wherein the memory controller is further configured to perform operations comprising:
transmitting, to the host device, an indication that the current level of the host device was not adjusted in accordance with the first request, after updating the stored indication of the first request in accordance with the second request.

9. A method, comprising:
receiving, at a memory controller of a memory system from a host device, a first request to adjust a current level of a memory module of the memory system;
storing, by the memory controller, an indication of the first request in a register associated with the memory controller; and
transmitting, to the host device, an indication that the first request is pending.

10. The method of claim 9, further comprising:
determining, by the memory controller, that a command queue associated with the memory controller includes one or more commands, wherein storing the indication of the first request in the register associated with the memory controller is performed in accordance with the determination that the command queue includes one or more commands.

11. The method of claim 10, further comprising:
determining, by the memory controller after transmitting the indication that the first request is pending, that the command queue is empty; and
adjusting, by the memory controller, the current level of the memory module in accordance with the stored indication of the first request and the determination that the command queue is empty.

12. The method of claim 11, further comprising:
transmitting, by the memory controller to the host device, an indication that the current level of the memory module has been adjusted, after adjusting the current level of the memory module.

13. The method of claim 9, wherein storing the indication of the first request comprises setting a first bit of the register to indicate that the indication of the first request is stored in the register.

14. The method of claim 9, wherein the first request comprises a bActiveICCLevel command.

15. The method of claim 9, further comprising:
receiving, by the memory controller from the host device, a second request to adjust the current level of the memory module while the indication of the first request is stored in the register; and
updating, by the memory controller, the stored indication of the first request in accordance with the second request.

16. The method of claim 15, further comprising:
transmitting, by the memory controller to the host device, an indication that the current level of the host device was not adjusted in accordance with the first request, after updating the stored indication of the first request in accordance with the second request.

17. An apparatus, comprising:
a memory controller:
coupled to a memory module through a data channel and configured to access data stored in the memory module through the data channel; and
coupled to a host device through a memory interface and configured to communicate with the host device over the memory interface,
the memory controller configured to perform operations comprising:
receiving, from the host device, a first request to adjust a current level of the memory module while one or more background operations are being performed on the memory module; and
transmitting, to the host device after receiving the first request, a first notification to instruct the host device to suspend the one or more background operations.

18. The apparatus of claim 17, wherein the first notification comprises an exception event notification, and wherein transmitting the first notification comprises adjusting a bit of an exception event register associated with the memory controller in accordance with the received first request.

19. The apparatus of claim 18, wherein the exception event register comprises a wExceptionEventStatus register.

20. The apparatus of claim 17, wherein the memory controller is further configured to perform operations comprising:
adjusting the current level of the memory module in accordance with the received first request after transmitting the first notification; and
transmitting, to the host device, a second notification that the current level of the memory module has been adjusted.

21. The apparatus of claim 20, wherein the second notification comprises an exception event notification, and wherein transmitting the second notification comprises adjusting a bit of an exception event register associated with the memory controller in accordance with the adjustment to the current level of the memory module.

22. The apparatus of claim 17, wherein the memory module comprises a flash memory device configured as a universal flash storage (UFS) device.

23. The apparatus of claim 17, wherein the first request comprises a bActiveICCLevel command.

24. A method, comprising:
receiving, at a memory controller of a memory system from a host device, a first request to adjust a current level of a memory module of the memory system while one or more background operations are being performed on the memory module; and
transmitting, by the memory controller to the host device after receiving the first request, a first notification to instruct the host device to suspend the one or more background operations.

25. The method of claim 24, wherein the first notification comprises an exception event notification, and wherein transmitting the first notification comprises adjusting a bit of an exception event register associated with the memory controller in accordance with the received first request.

26. The method of claim 25, wherein the exception event register comprises a wExceptionEventStatus register.

27. The method of claim 24, further comprising:
adjusting, by the memory controller the current level of the memory module in accordance with the received first request after transmitting the first notification; and
transmitting, by the memory controller to the host device, a second notification that the current level of the memory module has been adjusted.

28. The method of claim 27, wherein the second notification comprises an exception event notification, and wherein transmitting the second notification comprises adjusting a bit of an exception event register associated with the memory controller in accordance with the adjustment to the current level of the memory module.

29. The method of claim 24, wherein the memory module comprises a flash memory device configured as a universal flash storage (UFS) device.

30. The method of claim 24, wherein the first request comprises a bActiveICCLevel command.
